(19) United States
(12) Patent Application Publication
(10) Pub. No.: US 2008/0117458 A1
(43) Pub. Date: May 22, 2008

(54) Printing system and method using preview function

(76) Inventors: Heui Sun Pyo, Seoul (KR); Min Seok Pyo, Seoul (KR)

Correspondence Address: HARNESS, DICKEY & PIERCE, P.L.C., P.O. BOX 828, BLOOMFIELD HILLS, MI, 48303, US

(21) Appl. No.: 11/985,047

(22) Filed: Nov. 13, 2007

(30) Foreign Application Priority Data
Nov. 14, 2006 (KR) 10-2006-0112358

(51) Int. Cl. G06F 3/12

(52) U.S. Cl. 358/1.15; 358/527

(57) ABSTRACT

The present invention relates to a printing system and method using a preview function, which can display the output form of copied material or printed material, identical to that of actually copied material or printed material, on a screen of the printing system. Therefore, the output form of printed material to be output, to which the same print setting value as that for printed material to be actually output has been applied, is provided through a preview function on the screen display unit of the printing system, thereby preventing the user from making a print error.

### BACKGROUND OF THE INVENTION

1. Field of the Invention

The present invention relates to a printing system capable of viewing printed material through a preview function, and more particularly to a printing system and method using a preview function, which can display the output form of copied material or printed material, identical to that of actually copied material or printed material, on a screen of the printing system.

2. Description of the Prior Art

In general, printing systems, such as a copier, a computer printer, a facsimile, a multi-function device, etc., print an image corresponding to input original image data on a recording medium, such as printing paper.

Recent multi-function devices and printing systems provide a print preview, a scan preview, and so on, and some printing systems provide even a preview function of displaying an image acquired through scanning on a liquid crystal display (LCD) equipped in the printing system.

FIGS. 1A and 1B are views illustrating an image screen obtained by a preview function and actually output material in a conventional printing system, for the purpose of comparison.

As shown in FIG. 1A, a preview screen 10 output on a monitor of a personal computer (PC) or the like displays printed material's image 12 including a layout 20 of the printed material to be output, and the layout 20 of the printed material to be displayed on the printed material's image 12 is applied to an actual printed material based on set paper margins and is output.

In this case, the printed material's layout 20 is displayed on the printed material's image 12, based on a left margin 22, a right margin 24, a top margin 26, and a bottom margin 28, all of which have been preset.

However, although such a preview function for printed material is generally provided by PCs connected with printing systems, there is a problem in that the printed material's image 12 displayed in the preview screen 10 is output with paper margins different from those of an actually-output printing paper 30.

That is, as shown in FIG. 1B, left, right, top, and bottom margins 42, 44, 46, and 48, respectively, of an actually printed material's layout 40 output on the printing paper 30 are entirely different from the set left, right, top, and bottom margins 22, 24, 26, and 28, respectively, shown in FIG. 1A.

In addition, when printed material's image displayed on a preview screen is applied to an actual output, since it is difficult to obtain printed material precisely identical to that desired by the user, there is a problem in that copy and print errors must be repeated.

Especially, when a multi-side printing function is used, or when a full-duplex printing device or a printing system employing a bookbinding function, such as a stapler, a punch, etc., is used, there is a problem in that the user can only expect a resultant material using an actually printed material and the layout of the printed material, but cannot check the resultant material in advance on the printing system.

Also, a copying operation has problems in that a preview function using a PC cannot be utilized, and that when the user sets various values for the copying operation or selects option values for bookbinding, the user cannot view printed material to be output before directly seeing the printed material.

In addition, a print error that printed material's image displayed on a preview screen is different from the printed material actually output on printing paper, causes a waste of resources, such as printing paper, toner, etc.

### SUMMARY OF THE INVENTION

Accordingly, the present invention has been made to solve the above-mentioned problems occurring in the prior art, and the present invention provides a printing system and method using a preview function, which displays the output form of an expected printed material on a screen display unit installed in the printing system, and enables the output form of the printed material displayed on the screen display unit to be identical to that of printed material actually output on printing paper.

In accordance with an aspect of the present invention, there is provided a printing system capable of checking printed material through a preview, the system including: an interface unit for detecting an operation control signal of the printing system, print setting data for an output object, which has been input by a user, and data transmitted from an external device; a rendering unit for generating a preset output form of the printed material according to the print setting data detected by the interface unit, and generating an image to be actually output based on the data transmitted from the external device; a screen display unit for displaying at least one of the output form and the image, which have been generated by the rendering unit; a printing unit for printing the image generated by the rendering unit; and a controller for outputting a print signal for printing the image generated by the rendering unit to the printing unit when the operation control signal has been detected from the interface unit, and outputting a display signal of the output form or the image generated by the rendering unit to the screen display unit when either the printing setting data has been detected from the interface unit or when data transmitted from an exterior has been detected, wherein the printed material output from the printing unit has an output form or image equal to that displayed on the screen display unit.

In addition, the printing system may further include a memory unit which stores data for a print setting of the output object detected from the interface unit, wherein the print setting data for the output object is stored as a profile.

In addition, the printing system may further include a bookbinding unit which performs an operation of stapling or punching the printed material which has been printed.

In addition, the data for a print setting of the print object may include at least one among a user setting margin, a magnifying power, a multi-side printing, a full-duplex printing, a stapling position, and a punching position.

In addition, the interface unit may include: a user interface unit for detecting an operation control signal of the printing system from the user, and detecting data for a print setting of the output object; and a data interface unit for transmitting/receiving data to/from the external device.

In accordance with another aspect of the present invention, there is provided a print control method of a printing system capable of checking printed material through a preview, the method including the steps of: a) when the printing system operates, performing a normal printing operation of the printing system, or determining if a print setting value for the printed material to be output has been changed; b) when it is determined in step a) that the print setting value has been changed, determining if whether or not to output a preview screen for an image to be printed according to the changed print setting value has been input; c) when the output for the preview screen has been input, generating an output form of the printed material to be output based on the print setting value changed in the step a), and outputting a preview screen of the generated output form; and d) when a print signal for the output form output in the preview screen has been input, performing a printing operation so that the printed material having an output form equal to that output on the preview screen is output.

In addition, the print control method may further include a step of, when a change in the setting value is requested in step a), storing the changed setting value as a user setting profile.

In addition, step b) may further include a scan preview step for acquiring detailed information about the printed material to be output.

In addition, when the normal printing operation of the printing system is performed in step a), the printing operation may be performed according to a preset print setting value.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are views illustrating an image screen obtained by a preview function and actually output material in a conventional printing system, for the purpose of comparison;

FIG. 2 is a block diagram illustrating the configuration of a printing system using a preview function according to an exemplary embodiment of the present invention;

FIG. 3 is a flowchart illustrating a printing method using a preview function according to a first embodiment of the present invention;

FIGS. 4A and 4B are views illustrating printed material according to the first embodiment of the present invention;

FIG. 5 is a flowchart illustrating a printing method using a preview function according to a second embodiment of the present invention; and

FIGS. 6A and 6B are views illustrating printed material according to the second embodiment of the present invention.

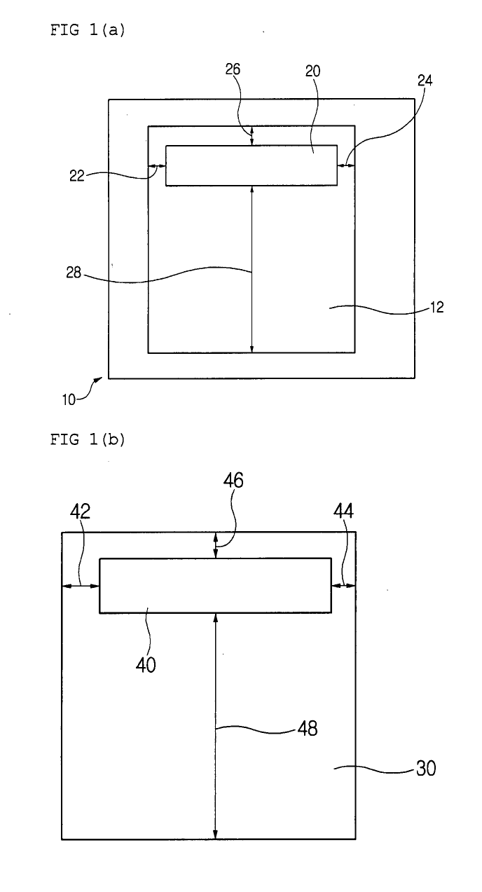

### DETAILED DESCRIPTION OF THE EXEMPLARY EMBODIMENTS

Hereinafter, exemplary embodiments of the present invention will be described with reference to the accompanying drawings.

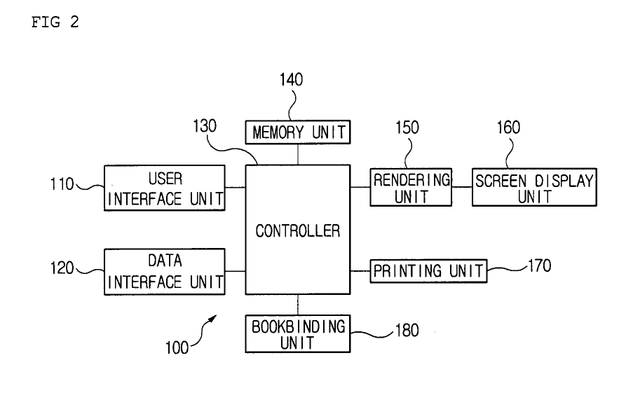

FIG. 2 is a block diagram illustrating the configuration of a printing system using a preview function according to an exemplary embodiment of the present invention.

As shown in FIG. 2, a printing system 100 using a preview function according to an exemplary embodiment of the present invention includes a large-sized screen display unit 160 for interfacing with a user so that the user can check the output form of printed material in advance through the preview function and exactly apply various settings selected by the user to the printed material before the printed material is output.

To this end, the printing system 100 includes an interface unit, a controller 130, a rendering unit 150, a screen display unit 160, and a printing unit 170. The interface unit includes a user interface unit 110 and a data interface unit 120, which receive a signal for controlling the operation of the printing system 100, data of printed material to be output, print data transmitted from an external device, including a PC and a scanner. The controller 130 controls the entire operation of the printing system 100. The rendering unit 150 renders the actual image of printed material to be output, and the output form of the printed material to be output based on setting data input by the user. The screen display unit 160 displays the image of the rendered printed material to be actually output, and the output form of the printed material which has been set by the user. The printing unit 170 prints the rendered image.

Also, the printing system 100 further includes a bookbinding unit 180 so as to have a multi-side printing function, a full-duplex printing function, and a bookbinding function, such as stapling, punching, etc., in addition to a copying function for copying a specific object, and a printing function for outputting text and image data which are transmitted from a PC connected to the printing system 100. Preferably, the printing system 100 may be a multi-function device.

The user interface unit 110 detects setting data and a control signal for the printing operation of the printing system 100, which are input by the user, and detects an output method (e.g., copying, single-side printing, full-duplex printing, multi-side printing, punching, etc.) of the printing system 100, in which the user interface unit 110 includes a keypad, a touch screen, and so on.

The data interface unit 120 receives data of an output object through data communication with an external device. When the printing system 100 performs a printing function for outputting data received from an exterior, the data interface unit 120 acts as a communication terminal for receiving the data from an external device (e.g., a PC) connected through a network or the like. When the printing system 100 performs a copying function, the data interface unit 120 acts as a device for receiving data from a data input device, such as a scanner (not shown).

In addition, the data interface unit 120 further includes a printer driver which enables the printing system 100 to operate as a printer, so that the printing system 100 can operate as a printer when the printing system 100 is connected to a device, such as the PC.

When the controller 130 detects an operation control signal (e.g., a copying signal, a print signal, a bookbinding signal, etc.) for the printing system 100 through the user interface unit 110, the controller 130 outputs an operation control signal for the rendering unit 150 so as to generate the output form of printed material, which has been created according to a result set to display the layout of the printed material to be output for the user, and to generate an operation control signal for the rendering unit 150, performs a control operation such that the output form of the printed material or the image of an actual printed material, generated by the rendering unit 150, can be output through the screen display unit 160, and outputs a print signal for controlling a printing operation to the printing unit 170.

That is, the controller 130 outputs a print signal to the printing unit 170 so as to output the same printed material as the output form of an expected printed material or as the image of printed material to be actually output, generated by the rendering unit 150, based on setting data by the user.

Also, the controller 130 outputs operation control signals for the rendering unit 150 and screen display unit 160, based on print setting data, i.e., print options (e.g. an edit page size setting, a layout margin setting, a layout to which setting values, such as magnification/reduction for the layout, are applied, a setting value for a stapler position, a setting value for a punch position, etc.), which have been received through the user interface unit 110 and the data interface unit 120, and on data received from an exterior.

The rendering unit 150 generates an image in which the layout of printed material to be output has been set, based on print setting options detected through the user interface unit 110 and data interface unit 120 according to the operation control signal received from the controller 130, and on data received from an external device.

That is, the rendering unit 150 generates the output form of printed material, in which a layout, an edit position, margins, a magnifying power, a position of a punch, and a position of a stapler have been preset to correspond to printing paper to output an actual printed material based on a print setting established by the user.

Also, the rendering unit 150 generates the output form of an expected printed material, which has been created based on print setting data established by the user, and generates the image of printed material to be actually output corresponding to the output form.

The screen display unit 160 displays the output form of the printed material and an image to be actually output, generated by the rendering unit 150, according to an operation control signal output from the controller 130 so that the user can view it.

Preferably, the screen display unit 160 may include an LCD, or may be provided on the entire surface thereof with a touch screen, together with the user interface unit 110.

Meanwhile, the screen display unit 160 may display an image to be actually output and the output form of printed material, while overlapping a part of the image on the output form, so as to enhance the convenience for the user.

The printing unit 170 prints the output form of the printed material and the image of printed material to be actually output, generated by the rendering unit 150, according to the print signal output from the controller 130. In this case, the printed material output through the printing unit 170 is printed in the output form with the same layout as that of the image displayed on the screen display unit 160.

The bookbinding unit 180 performs operations of stapling and punching the material which has been printed.

Reference numeral 140 represents a memory unit. The memory unit 140 stores print options and data for a print setting with respect to an output object, which are detected trough the user interface unit 110. In this case, the print options and the print setting data are stored as a profile and managed.

That is, the user appoints information about a magnifying power, a printing method, an option method, etc., and then stores the appointed information as a profile (or a hot key), so that when the user performs the same task in the future, it is possible to bypass the complex setting procedure and a time period required for the setting by reading the profile stored in the memory unit 140.

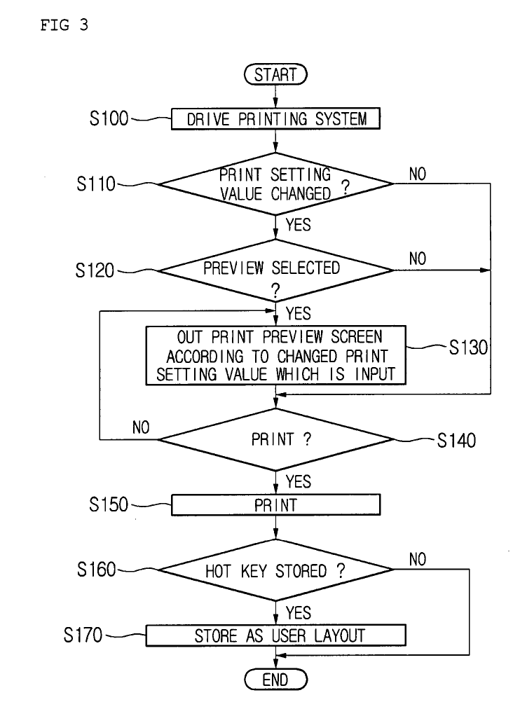

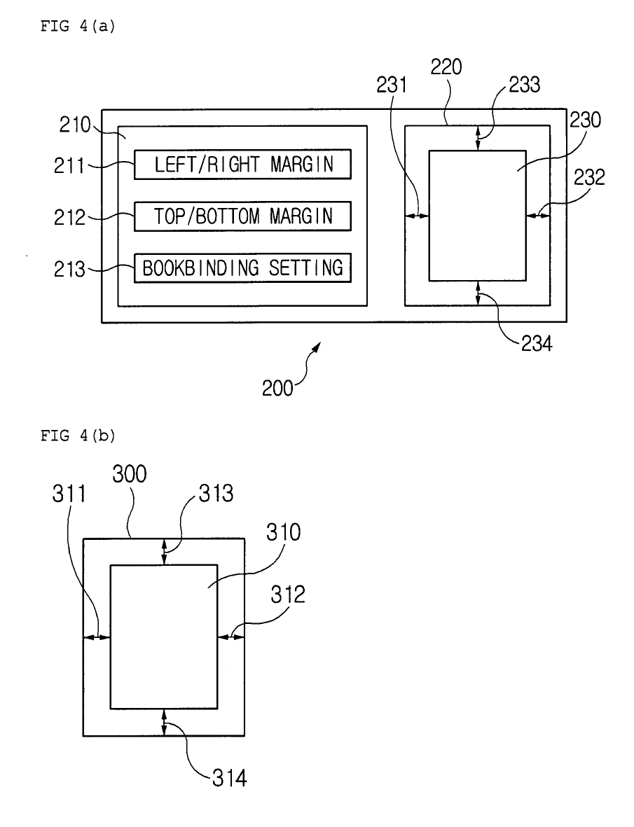

FIG. 3 is a flowchart illustrating a printing method using a preview function according to a first embodiment of the present invention, and FIGS. 4A and 4B are views illustrating printed material according to the first embodiment of the present invention.

Referring to FIGS. 2 to 4B, when the user inputs a control signal to perform any one operation, among copying, printing, and bookbinding, through the user interface unit 110, the controller 130 applies power to the printing system 100 so as to operate the printing system 100 (step 100).

After step 100, the controller 130 analyzes the control signal input through the user interface unit 110, and determines if a normal print operation (e.g., a normal copying which outputs printed material based on a basic layout preset through a single-side printing) of the printing system 100 is requested, and if a print setting request for changing the layout of the printed material to be output by changing a print setting value of the printing system 100 is input (step 110).

When it is determined in step 110 that the request for changing a print setting value of the printing system 100 has been received through the user interface unit 110, the controller 130 determines if a preview screen output request for an image to be printed according to the change value detected through the user interface unit 110 is input (step 120).

When it is determined in step 120 that the preview screen output request for the image to be printed according to the change value has been input, the controller 130 controls the rendering unit 150 to generate the output form of the printed material to be output, based on a changed print setting value input through the user interface unit 110, and outputs a preview screen for the output form of the generated printed material to the screen display unit 160 (step 130).

That is, as shown in FIG. 4A, when a change of a print setting value is requested in step 110, and a preview for the output form of an expected printed material in which the changed setting value has been reflected is requested in step 120, a setting value image 210 displaying print setting information so that a print setting can be input, together with an image 220 of the expected printed material, is displayed as a preview screen 200 through the screen display unit 160.

Meanwhile, although the embodiment of the present invention is illustrated about a case where a touch screen is installed in the screen display unit 160, and a setting value is acquired through the setting value image 210 for a print setting input, a changed setting value may be acquired through a separate key input unit.

Also, the embodiment of the present invention is described about only margin setting of a layout, for convenience of description. However, the setting value may include changing values for all of an edit page size setting, a layout margin setting, a layout to which setting values, such as magnification/reduction of the layout, are applied, a setting value for a stapler position, a setting value for a punch position, etc.

When the user inputs change values for a layout through a left/right margin setting column 211, a top/bottom margin setting column 212, and a bookbinding setting column 213, which are displayed in the setting value image 210, the controller 130 transmits the input change values to the rendering unit 150, and then the rendering unit 150 changes the position of the layout 230 by applying the input values in real time so as to change the output form of printed material to be output.

For example, when the user changes a setting value through the left/right margin setting column 211, the left margin 231 and right margin 232 of the layout 230 for printed material are changed, and when the user changes a setting value through the top/bottom margin setting column 212, the top margin 233 and bottom margin 234 of the layout 230 for the printed material are changed.

Accordingly, the output form of the printed material to be output, to which the changed layout 230 has been applied, is output in the printed material's image 220 of the preview screen 200, and the changed print setting value is stored in the memory unit 140.

Meanwhile, as shown in FIG. 4B, the changed print setting value is applied as an actual value to the printing paper 300, so that the layout of the actual printed material on the printing paper 300 is applied in the same manner as the layout 230 in the printed material's image 220.

That is, a print setting value for an actual print is changed depending on a change in a setting value in the setting value image, in such a manner as to change the left margin 311 and right margin 312 for the layout 310 of an actual printed material when a print setting value has been changed through the left/right margin setting column 211, and to change the top margin 313 and bottom margin 314 for the layout 310 of an actual printed material when a print setting value has been changed through the top/bottom margin setting column 212.

After step 130, the controller 130 determines if a print signal for the output form of the expected printed material displayed on the preview screen 200 is input (step 140), in which the controller 130 returns to step 130 when there is no input print signal. When a print signal is input, the printing unit 170 performs a printing operation so as to print printed material which has the same layout as the output form of the printed material's image 220 displayed in the preview screen 200, that is, as the output form of the printed material to be output, based on the change values set in step 130 (step 150).

After step 150, the controller 130 determines if the print setting value changed in step 130 is to be stored as a user setting profile, generating a hot key (step 160). When it is determined in step 160 that the print setting value is not to be stored, the printing operation ends. In contrast, when it is determined in step 160 that the print setting value is to be stored, the set value is stored as a user layout in the memory unit 140 (step 170), before ending the printing operation.

Meanwhile, either when a change in the print setting value is not input in step 110, or when selection for a preview is not input in step 120, the printing operation is performed based on a preset print setting value.

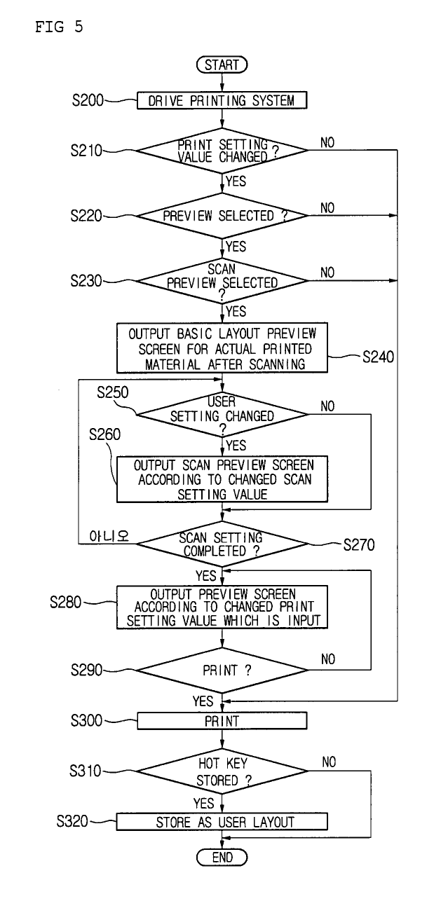

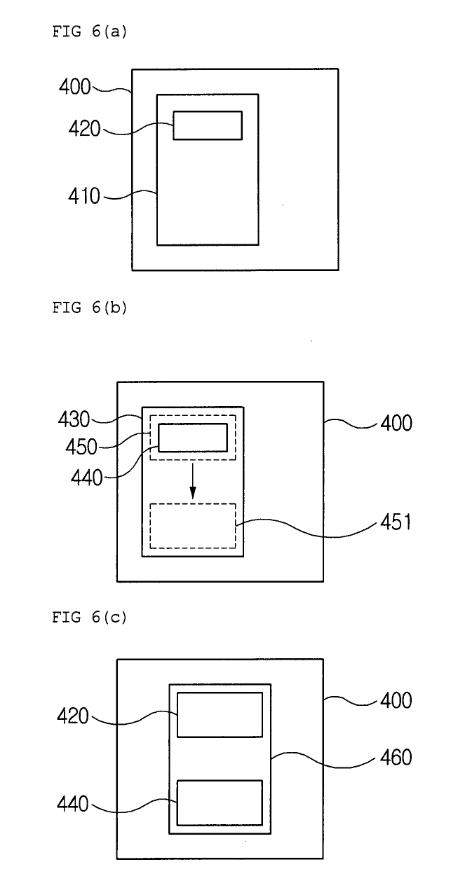

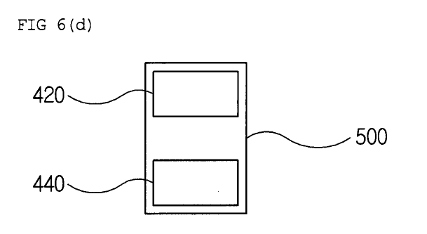

FIG. 5 is a flowchart illustrating a printing method using a preview function according to a second embodiment of the present invention, and FIGS. 6A and 6B are views illustrating printed material according to the second embodiment of the present invention.

Referring to FIGS. 2 and 5, as well as FIGS. 6A and 6B, when the user inputs a control signal to perform any one operation, among copying, printing, and bookbinding, through the user interface unit 110, the controller 130 applies power to the printing system 100 so as to operate the printing system 100 (step 200).

After step 200, the controller 130 analyzes the control signal input through the user interface unit 110, and determines if a normal print operation of printing system 100 is requested, and if a request for changing a layout of printed material to be output, that is, a request for changing the output form of the printed material by changing a print setting value of the printing system 100 is input (step 210).

When it is determined in step 210 that the request for changing a print setting value of the printing system 100 has been received through the user interface unit 110, the controller 130 determines if a preview screen output request for the output form of the printed material to be output according to a change value detected through the user interface unit 110 is input (step 220).

When it is determined in step 220 that a preview screen output request for the output form of the printed material to be output according to the change value has been input, the controller 130 determines if a preview setting which uses scanning is input (step 230). When a scan preview for the printed material to be output has been requested, the controller 130 scans the printed material to be output by means of a scanner (not shown), and outputs a detailed image of the scanned printed material to be output as a scan preview screen according to a preset basic setting value (step 240).

After step 240, the controller 130 determines if a change in the setting of the scanned image output in the scan preview screen is input (step 250). When a change in the setting of the scanned image has been input, the controller 130 performs a range change, an increase/decrease of a magnifying power, a margin change, a position change, and an edit with respect to the scanned image, as well as scanned image's overlapping and storing, based on the input setting value, and then outputs the changed scanned image as a scan preview screen (step 260).

A case where a setting change of overlapping and outputting data obtained by scanning both sides of the printed material is performed in step 260 will now be described in more detail. As shown in FIGS. 6A to 6D, when a scan preview is selected, a scan layout screen 400 of printed material to be output is displayed though the screen display unit 160 of the printing system 100.

When a scan preview is selected, the front side of the printed material to be output is scanned by a scanner, a first scanned image 410 which displays first scanned data 420 obtained through the scanning is output on the scan layout screen 400, and the first scanned image 410 is temporarily stored in the memory unit 140.

Thereafter, as shown in FIG. 6B, the rear side of the printed material to be output is scanned by the scanner, and a second scanned image 430 which displays second scanned data 440 obtained through the scanning is output on the scan layout screen 400. In this case, the second scanned data 440 is designated as a user setting block 450 by means of an input means, such as a touch screen, is moved to a new position 451, and is established at the new position 451.

Next, as shown in FIG. 6C, a new scanned image 460 to be printed is output on the scan preview screen 400, and the first scanned data 420 stored in the memory unit 140 and the second scanned data 440 having been moved to the new position 451 are overlappingly output on the scanned image 460 to be printed.

Thereafter, as shown in FIG. 6D, the first scanned data 420 and the second scanned data 440 are set such that they are printed on a printing paper 500 in the same manner as overlappingly output on the scanned image 460.

After step 260, it is determined if a scanned data's change set by the user has been completed (step 270). When it is determined that the scanned data's change set by the user has not been completed, step 250 is again performed. In contrast, when it is determined that the setting for the scanned data has been completed, the controller 130 controls the rendering unit 150 to generate the output form of an expected printed material, based on a changed print setting value input through the user interface unit 110, and outputs a preview screen for the output form of the generated printed material to the screen display unit 160 (step 280).

After step 280, the controller 130 determines if a print signal for the output form of the expected printed material displayed on the preview screen is input (step 290), in which the controller 130 returns to step 280 when there is no input print signal. When a print signal is input, the printing unit 170 performs a printing operation so as to print the material which has the same layout as the output form of the expected printed material's image displayed in the preview screen based on the change value set in step 280 (step 300).

After step 300, the controller 130 determines if the print setting value changed in step 280 is to be stored as a user setting profile, generating a hot key (step 310). When it is determined in step 310 that the print setting value is not to be stored, the printing operation ends. In contrast, when it is determined in step 310 that the print setting value is to be stored, the set value is stored as a user layout in the memory unit 140 (step 320), before ending the printing operation.

Meanwhile, either when a change in the print setting value is not input in step 210, or when selection for a preview is not input in step 220, the printing operation is performed based on a preset print setting value.

Accordingly, the user can view the output form of an expected printed material generated according to a layout to which values set by the user has been applied, through a preview on the screen display unit 160 installed in the printing system 100, so that the user can check a set printed material before the set printed material is printed on an actual printing paper.

As described above, the present invention provides the output form of printed material to be output, to which the same print setting value as that for printed material to be actually output has been applied, through a preview function on the screen display unit of the printing system, thereby preventing the user from making a print error.

Also, the present invention provides a preview function provided in a PC or a preview image of printed material to be output, which cannot be viewed during a copying operation in the conventional copier, thereby enhancing the convenience for the user.

Also, a print option and/or a setting change desired by the user can be checked in real time, so that it is possible to rapidly check printed material to be output.

Also, various pieces of change information set by the user are stored in associated with a hot key, so that the printing task can be rapidly performed when the same printing operation is performed in the future.

What is claimed is:

1. A printing system capable of checking printed material through a preview, the system comprising:
an interface unit for detecting an operation control signal of the printing system, print setting data for an output object, which has been input by a user, and data transmitted from an external device;
a rendering unit for generating a preset output form of the printed material according to the print setting data detected by the interface unit, and generating an image to be actually output based on the data transmitted from the external device;
a screen display unit for displaying at least one of the output form and the image, which have been generated by the rendering unit;
a printing unit for printing the image generated by the rendering unit; and
a controller for outputting a print signal for printing the image generated by the rendering unit to the printing unit when the operation control signal has been detected from the interface unit, and outputting a display signal of the output form or the image generated by the rendering unit to the screen display unit when either the printing setting data has been detected from the interface unit or when data transmitted from an exterior has been detected,
wherein the printed material output from the printing unit has an output form or image equal to that displayed on the screen display unit.

2. The system as claimed in claim 1, further comprising a memory unit which stores data for a print setting of the output object detected from the interface unit, wherein the print setting data for the output object is stored as a profile.

3. The system as claimed in claim 1 or 2, further comprising a bookbinding unit which performs an operation of stapling or punching the printed material which has been printed.

4. The system as claimed in claim 1, wherein the interface unit comprises:
a user interface unit for detecting an operation control signal of the printing system from the user, and detecting data for a print setting of the output object; and
a data interface unit for transmitting/receiving data to/from the external device.

5. A print control method of a printing system capable of checking printed material through a preview, the method comprising the steps of:
a) when the printing system operates, performing a normal printing operation of the printing system, or determining if a print setting value for the printed material to be output has been changed;
b) when it is determined in step a) that the print setting value has been changed, determining if whether or not to output a preview screen for an image to be printed according to the changed print setting value has been input;
c) when the output for the preview screen has been input, generating an output form of the printed material to be output based on the print setting value changed in the step a), and outputting a preview screen of the generated output form; and
d) when a print signal for the output form output in the preview screen has been input, performing a printing operation so that the printed material having an output form equal to that output on the preview screen is output.

6. The method as claimed in claim 5, further comprising a step of, when a change in the setting value is requested in step a), storing the changed setting value as a user setting profile.

7. The method as claimed in claim 5, wherein step b) further comprises a scan preview step for acquiring detailed information about the printed material to be output.

8. The method as claimed in claim 5, wherein when the normal printing operation of the printing system is performed in step a), the printing operation is performed according to a preset print setting value.
